(19) United States
(12) Patent Application Publication
(10) Pub. No.: US 2015/0074603 A1
(43) Pub. Date: Mar. 12, 2015

(54) MENU DISPLAY DEVICE, MENU DISPLAY METHOD, MENU DISPLAY PROGRAM, TELEVISION RECEIVER PROVIDED WITH MENU DISPLAY DEVICE, AND RECORDING MEDIUM

(71) Applicant: Sharp Kabushiki Kaisha, Osaka-shi (JP)

(72) Inventors: Hiroki Abe, Osaka-shi (JP); Hironori Inoue, Osaka-shi (JP); Masao Kurino, Osaka-shi (JP); Yosuke Iga, Osaka-shi (JP); Takamasa Shimizu, Osaka-shi (JP)

(73) Assignee: Sharp Kabushiki Kaisha, Osaka-shi (JP)

(21) Appl. No.: 14/394,510

(22) PCT Filed: Mar. 27, 2013
(86) PCT No.: PCT/JP2013/059075

§ 371 Date: Oct. 15, 2014

(30) Foreign Application Priority Data
Apr. 17, 2012 (JP) 2012-094255
Mar. 26, 2013 (JP) 2013-065213

(51) Int. Cl. G06F 3/0482

(52) U.S. Cl. CPC G06F 3/0482
USPC 715/823

(57) ABSTRACT

A focus frame (500) (i) is provided on a menu screen (410) on which a number of menu items to be selected (121a, 121b, 121c, 122a, and 122b) and the like are displayed and (ii) is located around a specific menu item to be selected (121a). A mark, such as an arrow, indicating a direction in which a menu item is selectable is put close to each of an upper side, a lower side, a right side, and a left side of the focus frame (500) so that a viewer can easily select a target menu item in accordance with an instruction indicated by the mark.

### TECHNICAL FIELD

The present invention relates to a menu display device, a method of displaying a menu, a menu display program, and a television receiver including the menu display device. More specifically, the present invention relates to (i) a menu display device, (ii) a method of displaying a menu, (iii) a menu display program, and the like, each of which is optimal to be used in a multifunctionalized television receiver in which a target menu item needs to be selected from a number of menu items.

### BACKGROUND ART

In connection with advancement in television, it has recently become possible to play a content on the Internet, play built-in HDD, display various types of information obtained from the Internet, or the like. This allows a television viewer not only to view a conventional television program but also to play/view various contents.

A fusion of related information between respective various contents has been carried out. For example, information related to a television program has been extracted, while the television program is being viewed, from the Internet so as to be displayed. Various services are further offered such as displaying a user's viewing tendency and selecting to display a recommended content from information on the Internet.

A selection of various functions described above or a selection of a target content is generally made as follows. That is, while a menu for selecting various functions or contents is being displayed on a screen, a user specifies, in the menu thus displayed, an item (a menu item) of a function that the user desires or an item (a menu item) indicating a content that the user desires to view.

On a menu screen on which menu items indicating various functions or contents are displayed, a specific menu item is generally selected and specified as follows. That is, a menu item of a specific function or a menu item indicating a specific content or the like, which menu item is being displayed on the screen, is to be selected by use of an up/down/right/left key of a remote control or the like (Note that, hereinafter, selecting a specific menu item is also referred to as focusing a specific menu item).

For example, a focused menu item is surrounded by a frame or a cursor is placed on the focused menu item so that the focused menu item can be distinguished from the other menu items. A specific menu item is selected, for example, by moving the “frame” surrounding the specific menu item. In this case, a “frame” for indicating a state in which a specific menu item is focused is referred to as a “focus frame.” Note that an operation of moving a “frame” or the like so as to focus a specific menu item is referred to as “to operate a focus frame,” “to move a focus frame,” or the like.

As described above, a focused menu item is surrounded by a frame or a cursor is placed on the focused menu item so that the focused menu item can be distinguished. Note that, however, in a case where a number of menu items need to be focused, it is likely to be difficult to recognize, at a glance, which menu item is focused. In a case where a number of functions need to be selected, a measure should be taken such as arranging menus to have a hierarchical structure or the like. Note, however, that it has not been easy to understand the hierarchical structure in advance. This causes a problem that it has tended to be complicated and difficult to understand how to select a necessary menu item.

Patent Literature 1 discloses a method of displaying menus having a plurality of hierarchies, in which method (i) it is possible to easily switch between a menu of a specific hierarchy and a menu of another hierarchy by a simple operation and (ii) it is easy to understand how the plurality of hierarchies are structured.

### CITATION LIST

### Patent Literature

Patent Literature 1

Japanese Patent Application Publication, Tokukai, No. 2010-113420 A (Publication Date: May 20, 2010)

### SUMMARY OF INVENTION

### Technical Problem

According to the invention disclosed in Patent Literature 1, in a case where a menu having a plurality of hierarchies is displayed, (i) a focused menu item is displayed in a selected menu hierarchy in a display manner different from those of other unfocused menu items and (ii) the focused menu item and a menu item in a hierarchy higher than the focused menu item are vertically displayed, for example, in an identical line.

With the arrangement, it is possible to easily recognize, in a menu having a plurality of hierarchies, for example, that which menu item in a higher hierarchy includes a menu item in a specific hierarchy. This makes it possible to relatively easily understand a hierarchical structure of the menu.

According to the method of displaying a menu item disclosed in Patent Literature 1, however, it may not be immediately recognizable in which direction a focus frame needs to be moved in order to focus another menu item. Specifically, in which direction, horizontally and vertically, the focus frame can be moved, may not be recognizable until the focus frame is actually moved. Accordingly, the method needs to be improved so that a direction in which the focus frame can be moved is indicated before the focus frame is operated.

In a case where a direction in which the focus frame is to be moved is simply designated, it is difficult to recognize whether such moving is intended to (i) change a category or (ii) select a menu item from a number of menu items in an identical category.

The menu items themselves need to be moved, in a case where (i) there are a number of menu items in an identical category so that all the menu items are not displayed on a single screen, (ii) the focus frame itself for indicating that a specific menu item is being focused is to be moved in a right-left direction of the screen, and (iii) the focus frame reaches an end of the screen. This causes a problem that the menu items are not displayed in a unified manner.

In a case where menu items in respective different categories are displayed, such menu items may be different in size from category to category. In such a case, a focused menu item itself may instantaneously change in size. This may cause a user not to cope with the change of the focused menu item in size, and ultimately may lose sight of the focused menu item.

In a case where a “frame” is simply put in order to indicate that the menu item is a focused one, a state in which the menu item is being focused is not noticeable, so that it is difficult for a user to recognize such a state.

The present invention has been made in view of the problems, and an object of the present invention is to provide a method of displaying a menu and a menu display program, in each of which it is easy to (i) recognize a direction in which a focus frame for selecting and designating a specific menu item in a menu is moved, (ii) distinguish a focused menu item, and (iii) select a target menu item.

### Solution to Problem

In order to attain the object, a menu display device of one aspect of the present invention is a menu display device in which a target menu item is selectable from a plurality of menu items which are displayed on a display screen, including: a control section which generates, on the display screen, a focus frame indicating that a specific menu item has been selected from the plurality of menu items, the control section putting, around the focus frame, a mark indicative of a direction in which a menu item is selectable, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

In order to attain the object, a method of displaying a menu of one aspect of the present invention is a method of displaying a menu in which method a target menu item is selectable from a plurality of menu items which are displayed on a display screen, including the step of: providing, on the display screen, a focus frame indicating that a specific menu item has been selected from the plurality of menu items, a mark, indicative of a direction in which a menu item is selectable, being put around the focus frame, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

### Advantageous Effects of Invention

As described above, the present invention can provide a method of displaying a menu and a menu display program in each of which a target menu item is easily selectable.

### BRIEF DESCRIPTION OF DRAWINGS

FIG. 1 is a view illustrating an example of a menu screen of a television receiver to which a method of displaying a menu and the like of the present invention are applied.

FIG. 2 is a view for explaining a screen switching by the television receiver to which the method of displaying a menu and the like of the present invention are applied.

FIG. 3 is a view illustrating an example of a hardware configuration of the television receiver to which the method of displaying a menu and the like of the present invention are applied.

FIG. 4 is a view for explaining in detail a movement of a focus frame in the method of displaying a menu and the like of the present invention.

FIG. 5 is a view illustrating an example of the focus frame.

FIG. 6 is a view illustrating a variation of the movement of the focus frame in the method of displaying a menu and the like of the present invention.

FIG. 7 is a view illustrating another example of the menu screen of the television receiver to which the method of displaying a menu and the like of the present invention are applied.

### DESCRIPTION OF EMBODIMENTS

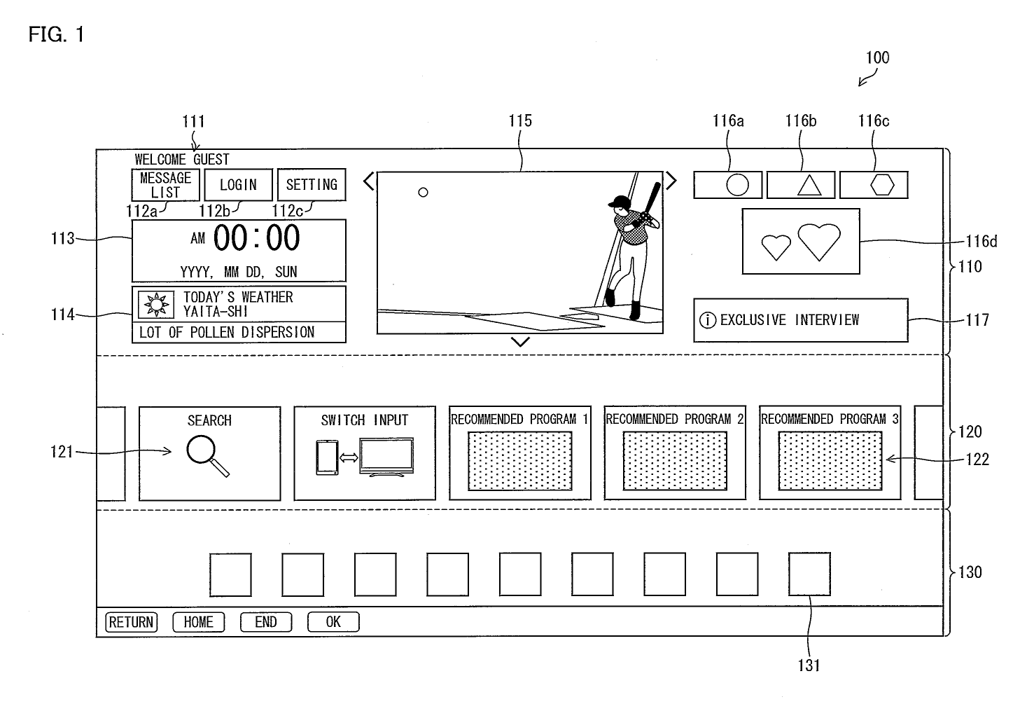

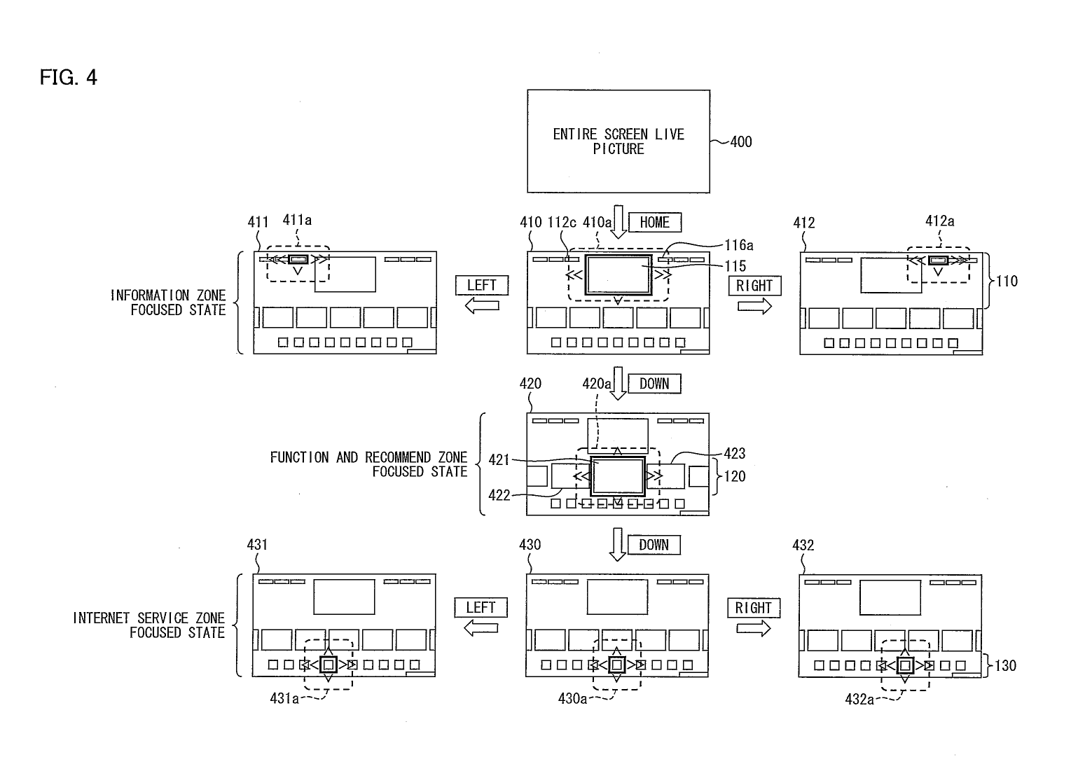

The following description will first discuss, with reference to FIGS. 1, 2, and 3, an overview of a screen configuration and a hardware configuration of a television receiver in accordance with an embodiment of the present invention. The embodiment of the present invention will be then discussed in detail with reference to FIGS. 4 through 7. In the following descriptions, various limitations preferable for implementing the present invention are provided. Note, however, that the technical scope of the present invention is not limited to the descriptions in the embodiments and the drawings. In the following descriptions, identical members are given identical reference numerals, and are not described repeatedly in detail.

### [Overview of Screen Configuration of Television Receiver]

### (Menu Screen)

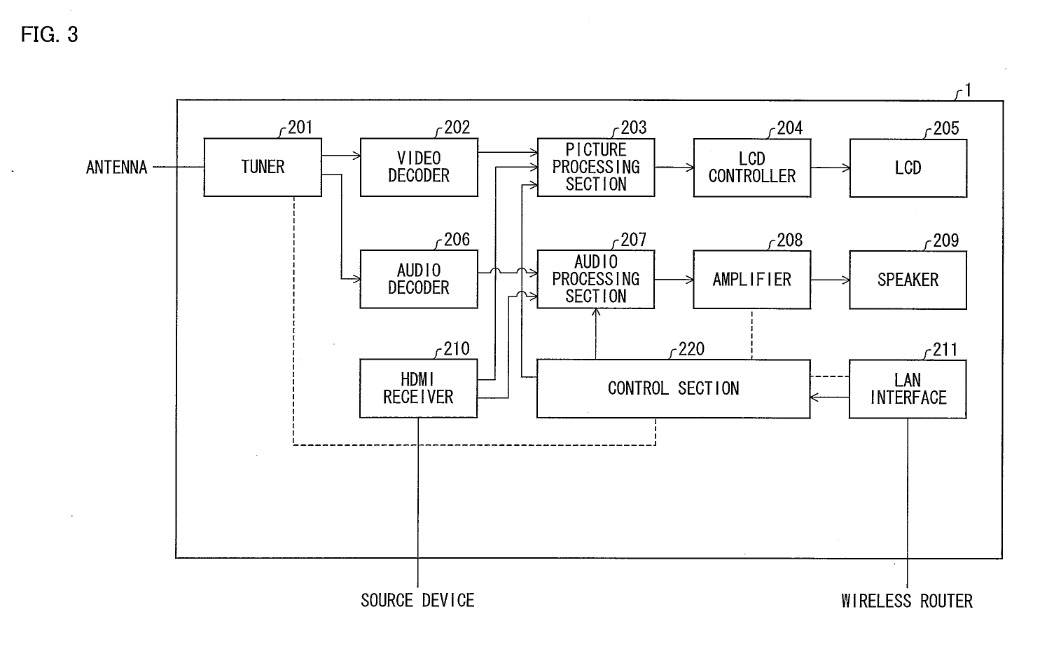

The following description will discuss a menu screen 100 which is displayed on a display by a television receiver (hereinafter abbreviated as a “television”) of the present embodiment with reference to FIG. 1. FIG. 1 is a screen configuration diagram illustrating a configuration of the menu screen 100 displayed on a display by a television 1 (see FIG. 3).

The menu screen 100 is a screen which is displayed by the television 1 in a case where a specific button (hereinafter referred to as a “home button”) provided on a remote controller (hereinafter abbreviated as a “remote”) is pressed. The menu screen 100 has an information zone 110, a function and recommend zone 120, and an Internet service zone 130 (see FIG. 1). The following description will discuss the information zone 110, the function and recommend zone 120, and the Internet service zone 130.

### (Information Zone)

The information zone 110 is a region for displaying various types of information, and can be rephrased as an information display region. The information zone 110 includes a user name display region 111, a message list button 112a, a login button 112b, a setting button 112c, a time display region 113, a weather display region 114, a live picture display region 115, banners 116a through 116c, a banner detail display region 116d, and an information display region 117.

The user name display region 111 is a region for displaying a user name. The television 1 has a function of logging in to a specific server provided by a production manufacturer of the television 1 or the like (hereinafter referred to as a “manufacturer server”). In a case where a login to the manufacturer server is completed, a user name which has been used during the login is displayed in the user name display region 111. Note that, until the login is completed, the television 1 displays, in the user name display region 111, a text string indicating a logout state (“Welcome Guest” in FIG. 1).

The message list button 112a is a button for calling a message list screen. In a case where an OK button of the remote is pressed while the message list button 112a is being focused, the television 1 causes a screen, which is to be displayed on the display, to be switched from the menu screen 100 to the message list screen. Note that the message list button 112a can be focused only in a case where the television 1 is connected to a network.

The login button 112b is a button for calling a login screen. In a case where the OK button of the remote is pressed while the login button 112b is being focused, the television 1 causes the screen, which is to be displayed on the display, to be switched from the menu screen 100 to the login screen. Note that the login button 112b can be focused only in a case where the television 1 is connected to a network.

The setting button 112c is a button for calling a setting screen. In a case where the OK button of the remote is pressed while the setting button 112c is being focused, the television 1 causes the screen, which is to be displayed on the display, to be switched from the menu screen 100 to the setting screen. Note that the setting button 112c can be focused regardless of whether or not the television 1 is connected to a network.

The time display region 113 is a region for displaying a current time. The current time can be displayed in the time display region 113 in any display format. According to the present embodiment, a display format “AM **:**/YYYY, MM, DD, Day of week” (“/” indicates a new line) is employed (see FIG. 1). Note that the current time displayed on the display region 113 can be obtained from, for example, a clock built in the television 1. Alternatively, the current time can be obtained from an NTP server connected to the television 1.

The weather display region 114 is a region for displaying weather information on an area where the television 1 is installed. The weather information can be displayed in the weather display region 114 in any display format. According to the present embodiment, a display format is employed in which a weather icon (an icon indicating that a weather will be clear and then cloudy is used in the example in FIG. 1), an area name (“Yaita-shi” in the example in FIG. 1), and a comment (“In the northern Kanto region, lot of pollen dispersion is expected” in the example in FIG. 1). Note that the weather information displayed in the weather display region 114 can be obtained from the manufacturer server or the like. Alternatively, the weather information can be extracted from data broadcasting.

The live picture display region 115 is a region for reducing and displaying a picture (a moving image or a static image) which has been displayed in full screen immediately before the screen is switched to the menu screen 100. For example, in a case where a broadcasting program has been displayed in full screen immediately before the screen is switched to the menu screen 100, the broadcasting program continue to be reduced and displayed in the live picture display region 115. In a case where a web page has been displayed in full screen immediately before the screen is switched to the menu screen 100, the web page continues to be displayed in the live picture display region 115. Note that the live picture display region 115 can be focused regardless of whether or not the television 1 is connected to a network. In a case where the OK button of the remote is pressed while the live picture display region 115 is being focused, the television 1 finishes displaying the menu screen 100 and resumes displaying the entire screen live picture.

The banners 116a through 116c are banners supplied from the manufacturer server. Examples of the banners 116a through 116c encompass a banner advertisement supplied from the manufacturer server. The banners 116a through 116c can be focused regardless of whether or not the television 1 is connected to a network. Detail information corresponding to a focused banner is displayed in the banner detail display region 116d. The banners 116a through 116c and the detail information corresponding to each of the banners 116a through 116c are downloaded from the manufacturer server while the television 1 is being connected to a network, and is then accumulated in the television 1.

The information display region 117 is a region for displaying a text string supplied from the manufacturer server. The text string displayed in the information display region 117 moves from a right end of the information display region 117 to a left end of the information display region 117. In a case where a last character of the text string frames out of the left end of the information display region 117, a first character of the text string frames in from the right end of the information display region 117.

Note that in the following description, out of UI (User Interface) elements constituting the information zone 110, a UI element which can be focused is collectively referred to as a menu item. Specifically, the message list button 112a, the login button 112b, the setting button 112c, the live picture display region 115, and the banners 116a through 116c serve as menu items.

### (Function and Recommend Zone)

The function and recommend zone 120 is a region for displaying panels for respective various functions (hereinafter referred to as “function panels”) 121 and panels for respective various recommended contents (hereinafter referred to as “recommended content panels”) 122. The function and recommend zone 120 can be rephrased as a panel display region. The function panels 121 and the recommended content panels 122 are displayed in a single horizontal row in the function and recommend zone 120.

The function panels 121 are panels for respective functions of the television 1. In a case where the OK button of the remote is pressed while one of the function panels 121 is being focused, the television 1 causes the screen, which is to be displayed on the display, to be switched from the menu screen 100 to a screen for using a function corresponding to the one of the function panels 121.

According to the present embodiment, a counterprogram panel, a smart search panel, a recoding list panel, a switch input panel, a program table panel, and a calendar panel are prepared as the respective function panels 121. For example, in a case where the OK button of the remote is pressed while the counterprogram panel is being focused, the television 1 causes the screen, which is to be displayed on the display, to be switched from the menu screen 100 to a “counterprogram selection screen.” In a case where the OK button of the remote is pressed while the smart search panel is being focused, the television 1 causes the screen, which is to be displayed on the display, to be switched from the menu screen 100 to a “smart search screen.”

The recommended content panels 122 are panels for respective recommended contents (a counterprogram, an unaired broadcasting program, a recoded program, and a web page) selected by the television 1. In a case where the OK button of the remote is pressed while one of the recommended content panels 122 is being focused, the television 1 starts displaying in full screen (i) a corresponding recommended content (in a case where the recommended content is a counterprogram, a recoded program, or a web page) or (ii) a recording reservation screen for carrying out a recording reservation of a corresponding recommended content (in a case where the recommended content is an unaired broadcasting program).

Note that, in the following description, out of UI (User Interface) elements constituting the function and recommend zone 120, a UI element which can be focused is collectively referred to as a menu item. Specifically, the function panels 121 and the recommended content panels 122 each serve as a menu item.

### (Internet Service Zone)

The Internet service zone 130 is a region for displaying icons 131 for respective various Internet services. In a case where the OK button of the remote is pressed while one of the icons is being focused, the television 1 causes the screen, which is to be displayed on the display, to be switched from the menu screen 100 to a screen for using an Internet service corresponding to the one of the icons 131.

According to the present embodiment, an IPTV icon, a photograph/magazine icon, a shopping icon, a search/TV portal icon, an Internet moving image icon, a communication icon, a life support icon, a service list icon, and a bookmark icon are prepared as the icons 131.

Note that the icons 131 for respective various Internet services are displayed only in a case where the television 1 is connected to a network. In a case where the television 1 is not connected to a network, it is preferable to display, in the Internet service zone 130, (i) a message indicating that the television 1 is not connected to a network, (ii) a button for calling a moving image content prompting a user to connect the television 1 to a network, (iii) a button for calling a network setting screen, or the like.

Note that, in the following description, out of UI (User Interface) elements constituting the Internet service zone 130, a UI element which can be focused is collectively referred to as a menu item. Specifically, the icons 131 serve as menu items.

### (Screen Switching)

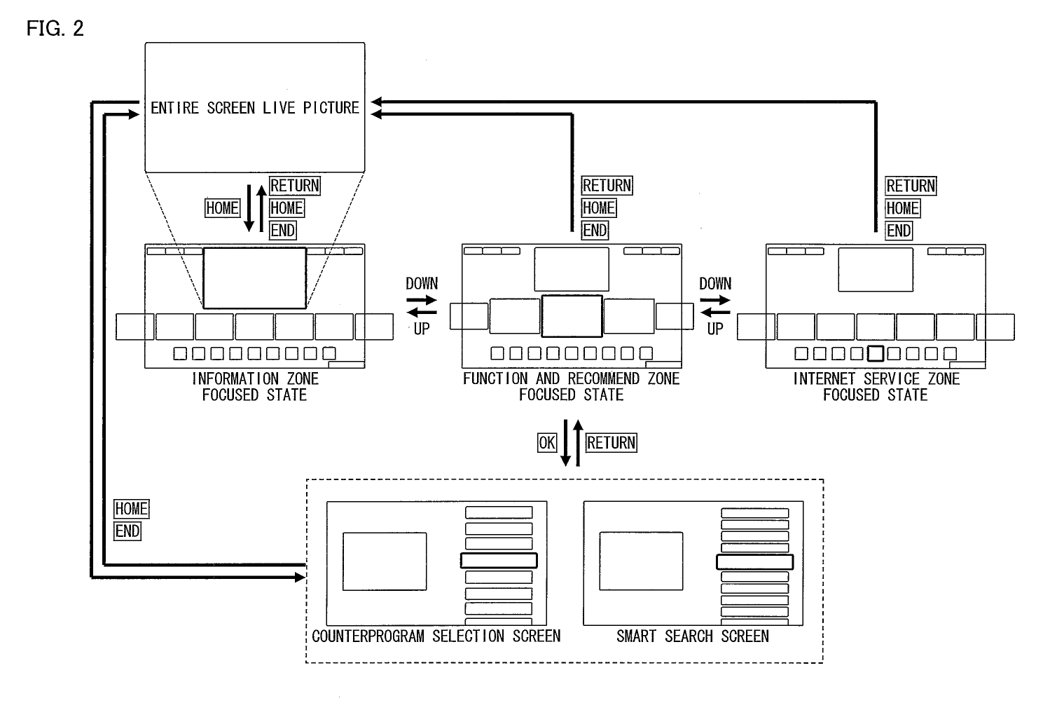

The following description will discuss a screen switching by the television 1 with reference to FIG. 2. FIG. 2 is a screen switching diagram illustrating a screen switching by the television 1.

In a case where the home button of the remote is pressed while a live picture such as a broadcasting program is being displayed in full screen, the television 1 causes the screen, which is to be displayed on the display, to be switched from the live picture (displayed in full screen) to the menu screen 100 (see FIG. 2).

States of the menu screen 100 are roughly classified into an information zone focused state, a function and recommend zone focused state, and an Internet service zone focused state. Note here that the information zone focused state is a state in which one of menu items included in the information zone 110 is focused. The function and recommend zone focused state is a state in which one of menu items included in the function and recommend zone 120 is focused. The Internet service zone focused state is a state in which one of menu items included in the Internet service zone 130 is focused. In any one of the aforementioned states, a focused menu item can be distinguished from the other menu items by a focus frame surrounding the focused menu item.

In a case where a right button of the remote is pressed in the information zone focused state, the television 1 changes a menu item, which is to be focused, to a menu item located close to a right side of a currently focused menu item. Similarly, in a case where a left button of the remote is pressed in the information zone focused state, the television 1 changes the menu item, which is to be focused, to a menu item located close to a left side of a currently focused menu item. Note that a movement of a focus in the information zone focused state is made by moving not a position of the menu item but a position of the focus frame.

In a case where a down button of the remote is pressed in the information zone focused state, the television 1 causes the state of the menu screen 100 to be switched from the information zone focused state to the function and recommend zone focused state (see FIG. 2). On the contrary, in a case where an up button of the remote is pressed in the function and recommend zone focused state, the television 1 causes the state of the menu screen 100 to be switched from the function and recommend zone focused state to the information zone focused state.

In a case where the right button of the remote is pressed in the function and recommend zone focused state, the television 1 changes the menu item, which is to be focused, to a menu item located close to a right side of a currently focused menu item. Similarly, in a case where the left button of the remote is pressed in the function and recommend zone focused state, the television 1 changes the menu item, which is to be focused, to a menu item located close to a left side of a currently focused menu item. Note that a movement of a focus in the function and recommend zone focused state is made by moving not a position of the focus frame but a position of the menu item.

In a case where the down button of the remote is pressed in the function and recommend zone focused state, the television 1 causes the state of the menu screen 100 to be switched from the function and recommend zone focused state to the Internet service zone focused state (see FIG. 2). On the contrary, in a case where the up button of the remote is pressed in the Internet service zone focused state, the television 1 causes the state of the menu screen 100 to be switched from the Internet service zone focused state to the function and recommend zone focused state.

In a case where the right button of the remote is pressed in the Internet service zone focused state, the television 1 changes the menu item, which is to be focused, to a menu item located close to a right side of a currently focused menu item. Similarly, in a case where the left button of the remote is pressed in the Internet service zone focused state, the television 1 changes the menu item, which is to be focused, to a menu item located close to a left side of a currently focused menu item. Note that a movement of a focus in the Internet service zone focused state is made by moving not a position of the menu item but a position of the focus frame.

Note that, in a case where a return button, the home button, or an end button of the remote is pressed while the menu screen 100 is being displayed, the television 1 finishes displaying the menu screen 100 and resumes displaying the entire screen live picture.

In a case where the OK button of the remote is pressed while one of the function panels 121 is being focused, the television 1 causes the screen, which is to be displayed on the display, to be switched from the menu screen 100 to a screen for using a function corresponding to the one of the function panels 121. For example, in a case where the OK button of the remote is pressed while the counterprogram panel is being focused, the television 1 causes the screen, which is to be displayed on the display, to be switched from the menu screen 100 to the “counterprogram selection screen”. In a case where the OK button of the remote is pressed while the smart search panel is being focused, the television 1 causes the screen, which is to be displayed on the display, to be switched from the menu screen 100 to the “smart search screen”.

In a case where the return button of the remote is pressed while the counterprogram selection screen, the smart search screen, or the like is being displayed, the television 1 causes the screen, which is to be displayed on the display, to be switched from the counterprogram selection screen, the smart search screen, or the like to the menu screen 100. In a case where the return button of the remote is pressed while the counterprogram selection screen, the smart search screen, or the like is being displayed, the television 1 finishes displaying the counterprogram selection screen, the smart search screen, or the like and resumes displaying the entire screen live picture.

Note that it is preferable that a focus frame, to be displayed around a focused menu item, blink. A cycle on which the focus frame blinks can be set, for example, to 0.5 Hz. This allows a user to easily recognize which menu item is focused, even in a case where menu items are colorful. Note, however, that, in a case where a focus frame is in a dark state when a focus is moved, it is difficult for a user to recognize that the focus has been moved. According to the present embodiment, such a problem is avoided by employing an arrangement in which a state of the focus frame is reset to a bright state each time the focus is moved. A color of the focus frame is not limited to a specific one. According to the present embodiment, yellow is employed so as to improve a visibility of a focus frame in a case where a background color is black.

In a case where a focus frame thus blinks so as to be noticeable, a user can more easily recognize the focus frame.

As described above, in a case where a blinking cycle of the focus frame is set, for example, to 0.5 Hz (i.e., one blinking every two seconds), a visibility of the focus frame can be improved without causing a problem that a user has an impression that the user is in a state of emergency, so as to rush the user to conduct an operation.

The television 1 can be arranged such that a difference in luminance between the bright state and the dark state in blinking of the focus frame is adjusted (e.g., the luminance difference is reduced) so that a luminance gradually changes during blinking of the focus frame. In a case where the luminance difference is thus reduced, it is possible to reduce (i.e., to reduce moderately or gently) a change in luminance from a bright state to a dark state and a change in luminance from a dark state to a bright state. This allows the above problem to be more effectively avoided.

The television 1 can be arranged such that a state of the focus frame is reset to a bright state each time the focus is moved. That is, the television 1 can be arranged such that a focus frame has a highest luminance when the focus frame is moved to focus a menu item. This allows a user to easily recognize which menu item is currently focused.

Note that, in a case where a focus frame is moved between categories (in a case where a focus frame is moved in a longitudinal direction), the focus frame is moved a distance longer than a distance the focus frame is moved in a case where the focus frame is moved between menu items (in a case where the focus frame is moved in a transverse distance). In a case where menu items included in respective zones (categories) differ in size from each other, it is possible to employ an arrangement in which a size of a focus frame is changed in accordance with a size of the menu item.

In a case where a focus frame is thus moved between the categories, a user more easily loses sight of the focus frame thus moved, as compare with a case where the focus frame is moved between the menu items. In such a case, it is preferable to improve a user's visibility by resetting the focus frame to a bright state immediately before the focus frame is moved.

### [Hardware Configuration of Television]

The following description will discuss a hardware configuration of the television 1 with reference to FIG. 3. FIG. 3 is a block diagram illustrating the hardware configuration of the television 1.

The television 1 includes a tuner 201, a video decoder 202, a picture processing section 203, an LCD controller 204, an LCD 205, an audio decoder 206, an audio processing section 207, an amplifier 208, a speaker 209, an HDMI (Registered Trademark) receiver 210, a LAN interface 211, and a control section 220 (see FIG. 3).

The tuner 201 demodulates an encoding video signal and an encoding audio signal from a broadcast wave of terrestrial digital broadcasting, BS broadcasting, or CS broadcasting. The video decoder 202 decodes the encoding video signal thus demodulated by the tuner 201. The video signal thus decoded by the video decoder 202 is supplied to the LCD controller 204 via the picture processing section 203. The LCD controller 204 controls the LCD 205 to display a picture indicated by the video signal which has been processed by the picture processing section 203. The audio decoder 206 decodes the encoding audio signal demodulated by the tuner 201. The audio signal thus decoded by the audio decoder 206 is supplied to the amplifier 208 via the audio processing section 207. The amplifier 208 drives the speaker 209 to output a sound indicated by the audio signal which has been processed by the audio processing section 207.

The HDMI receiver 210 receives a video signal and an audio signal which are supplied from the source device 5. The video signal and the audio signal received by the HDMI receiver 210 is supplied to the picture processing section 203 and the audio processing section 207, respectively. The video signal and the audio signal are then outputted from the LCD 205 and the speaker 209, respectively, as with the video signal and the audio signal demodulated by the tuner 201.

The LAN interface 211 obtains a web content and a VOD content from a web server and a VOD server, respectively. These network contents are both decoded by the control section 220 by use of software. A video signal and an audio signal indicative of the network contents thus decoded by the control section 220 are supplied to the picture processing section 203 and the audio processing section 207, respectively. The video signal and the audio signal are then outputted from the LCD 205 and the speaker 209, respectively, as with the video signal and the audio signal demodulated by the tuner 201.

In addition to the functions described above, the control section 220 has a function of generating a video signal indicative of the menu screen 100 illustrated in FIG. 1. The video signal indicative of the menu screen 100 which video signal is generated by the control section 220 is supplied to picture image processing section 203. The video signal is then outputted from the LCD 205, as with the video signal demodulated by the tuner 201. Note that the control section 220 can obtain, from the manufacturer server, via the LAN interface 211, various types of information which are required for generating the video signal indicative of the menu screen 100.

The control section 220 further functions as a menu display device which realizes a method (described below) of displaying a menu.

Note that the control section 220 includes a CPU (Central Processing Unit), a ROM (Read Only Memory), a RAM (Random Access Memory), and the like. The CPU executes a program stored in the ROM, the RAM, and the like so that the foregoing functions are each carried out.

### [Configuration and Movement of Focus Frame]

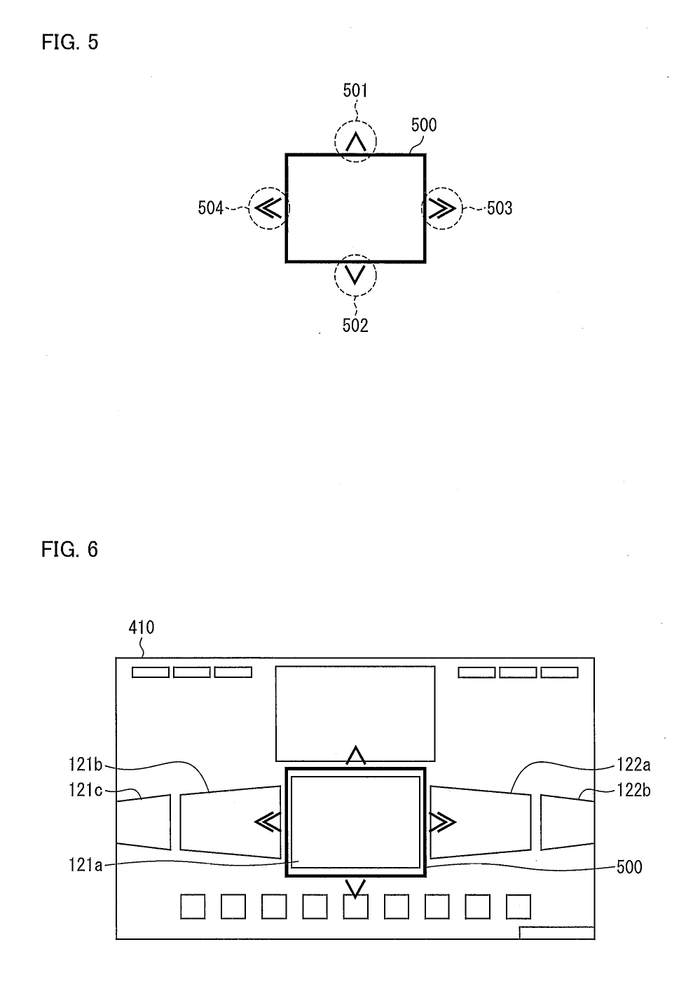

The following description will discuss in detail a configuration of the focus frame itself and a movement of the focus frame with reference to FIGS. 4 and 5.

### (Configuration of Focus Frame)

FIG. 5 specifically illustrates an example configuration of the focus frame. The focus frame is made up of a rectangular frame 500 and arrows 501, 501, 503, and 504 put close to an upper side, a lower side, a right side, and a left side of the frame 500, respectively. The focus frame 500 is used in a case where one of a number of menu items displayed on the display screen is to be selected. For example, a user moves the focus frame 500 onto a menu item that the user desires to select so as to select a target menu item.

The arrows 501, 501, 503, and 504, put close to the respective sides of the frame 500, indicate directions each of which the focus frame 500 can select. For example, the focus frame 500 can be moved in the directions indicated by the respective arrows. That is, it is possible to move the focus frame 500 located on a specific menu item so as to focus another menu item. Note that it is also possible that a menu item to be selected is moved so as to select another menu item (later described) while the focus frame 500 is being fixed. For example, as described above, in a case where the function and recommend zone is focused, the focus frame itself is fixed and a menu item to be selected is moved.

FIG. 5 illustrates two types of arrows, i.e., single arrows 501 and 502 and double arrows 503 and 504 for the focus frame 500. The focus frame 500 can be moved in directions indicated by the double arrows at a speed higher than that in the direction indicated by the single arrows. Specifically, in a case where the up button or the down button of the remote is pressed, the focus frame is moved at a relatively low speed. Similarly, in a case where the right button or the left button is “simply pressed (for a short time period),” the focus frame is moved at a relatively low speed. Note, however, that in a case where the right button or the left button is pressed and held down (for a long time), the focus frame 500 is moved in a right direction or a left direction at a high speed, respectively. Accordingly, in a case where the focus frame is moved in the right-left direction, a menu item is selectable at a relatively high speed. Note that the arrows cause the focus frame 500 to move differently depending on where the focus frame is located and the like.

The television 1 can be arranged such that arrows displayed around the focus frame 500 (more specifically, the number of arrows pointing identical directions) are changed in accordance with the number of menu items which are selectable, by moving the focus frame 500.

For example, in a case where menu items in a range from one (1) to ten are selectable by moving the focus frame 500, it is possible to add a single arrow to each of the double arrows 503 and 504 illustrated in FIG. 5 so as to be a triple arrow. In a case where menu items in a range from 11 to 20 are selectable by moving the focus frame 500, it is possible to add a double arrow to each of the double arrows 503 and 504 illustrated in FIG. 5 so as to be a quadruple arrow.

In a case where a number of selectable menu items are included in an identical zone extending in an identical direction when viewed from the focus frame 500, the television 1 can show a user the approximate number of selectable menu items by increasing the number of arrows in accordance with the number of menu items. This allows the user to recognize, by simply taking a glance at an arrow displayed around the focus frame 500, the approximate number of selectable menu items included in the identical zone in a direction pointed by the arrow.

The focus frame 500 serves as a marker indicating that a specific menu item is selected, and therefore needs to be easily visible on a display screen. Accordingly, it is necessary to cause the focus frame 500 to be easily visible, for example, by displaying the focus frame 500 in yellow, which is a noticeable color, in a dark screen or by displaying the focus frame 500 in a relatively dark color in a bright screen. As has been described, it is effective to cause the focus frame 500 to blink at a low frequency of approximately 0.5 Hz.

Note that marks such as arrows, put around the focus frame, are not limited to the arrows indicated in FIG. 5, but can be in various forms in consideration of design. It is also possible that marks different in shape can be employed in accordance with contents of selectable menu items, for example, in accordance with function panel and recommended content panel. That is, in a case where marks different in design are put with respect to respective menu items in different categories, a user recognizes, by simply viewing a mark put with respect to the focus frame, selectable categories and their selectable menu items.

It is possible to gradually increase a size of the focus frame while maintaining a shape of the focus frame, in a case where (i) menu items to be selected differ in size from each other and (ii) the user wishes to change from a selecting state where menu items are displayed in a small size on the display screen to a selecting state where menu items are displayed in a large size. In this case, since the shape of the focus frame is maintained, a location of the focus frame can be easily recognized.

Alternatively, it is possible, instead of changing a configuration of the focus frame 500 itself, to enlarge and display a menu item itself selected by the focus frame. This allows the menu item thus selected to be clearly visible or text or the like written on the menu item to be easily readable.

According to FIG. 4 described below, the frame 500 and the arrows 501 through 504 are surrounded by a broken line and are indicated as a focus frame 410a or the like. Specifically, for example, the focus frame 410a does not indicate the broken line 410a itself but indicates a focus frame made up of (i) a frame surrounding the live picture display region 115, (ii) a single arrow put on a lower side of the frame, and (iii) double arrows put on right and left sides of the frame.

(In a Case where Information Zone is Focused)

As has been described with reference to FIGS. 1 and 2, in a case where the home button of the remote is pressed while the television 1 is displaying an entire screen live picture, the television 1 causes the screen displayed to be switched to the menu screen 100 (see FIGS. 1 and 2).

This is illustrated in FIG. 4, together with a movement of the focus frame. In a case where the home button or the down button of the remote is pressed, a display screen 400 of the television receiver on which display screen a live picture is displayed in full screen is switched to the menu screen 410 (corresponding to the menu screen 100 illustrated in FIG. 1) in which the information zone is focused (see FIG. 4). According to the menu screen 410 in which the information zone is focused, the live picture is displayed in the live picture display region 115. Moreover, the focus frame 410a, indicating that a live picture display part is selected, is located on the menu screen 410.

The focus frame 410a is illustrated as a frame surrounding the live picture display region 115. The focus frame 410a is caused to blink at a low frequency, for example, at approximately 0.5 Hz, so as to clarify presence of the focus frame 410a. The focus frame can be in a color of high visibility, for example, yellow, so as to be clearly distinguished from a picture around the focus frame. As has been described, in a case where a focus frame is in a dark state when a focus frame is moved (when a movement of focus occurs), a problem occurs that it becomes difficult for a user to recognize that the focus has been moved. According to the present embodiment, such a problem is avoided by employing an arrangement in which a state of the focus frame is reset to a bright state each time the focus is moved.

Note that it is needless to say that a focus frame is controlled as described above not only in a case where the focus frame is located in the information zone 110. A focus frame is controlled also in a case where the “function and recommend zone” or the “Internet service zone” is focused (later described).

A mark “<<” (double arrow in the left direction) and a mark “>>” (double arrow in the right direction) are put adjacent to a right side of the focus frame 410a and a left side of the focus frame 410a, respectively. A single arrow (mark) pointing a lower direction is put adjacent to a lower side of the focus frame 410a. As has been described with reference to FIG. 5, these marks indicate directions in each of which a menu item is selectable. The double arrow indicates that a menu item is selectable at a speed higher than that in the direction indicated by the single arrow.

In a case where the left button of the remote is pressed while the menu screen 410 is being displayed, a menu screen 411 is displayed. This indicates that the focus frame is moved to a location of 411a so that the setting button 112c (see FIG. 1), which is one of the menu items, is focused (selected). According to the present embodiment, a high speed selection is possible in a right-left direction. The high speed selection can be made by pressing and holding down the left button of the remote. Similarly, in a case where the right button of the remote is pressed while the menu screen 410 is being displayed, a menu screen 412 is displayed. In this case, the banner 116a (see FIG. 1), which is one of the menu items, is focused. The high speed selection can be made by pressing and holding down the right button.

In a case where the OK button of the remote is pressed while a specific menu item is being focused, a function or the like of the specific menu item thus focused is carried out.

(In a Case where Function and Recommend Zone is Focused)

In a case where the down button of the remote is pressed while the menu screen 410 is being displayed, (i) the screen is switched to a menu screen 420 in which the function and recommend zone is focused and (ii) a focus frame 420a is switched to a center part of the function and recommend zone. As has been described, the plurality of function panels 121 or the plurality of recommended content panels 122 are located as menu items in the function and recommend zone (see FIG. 1). In the menu screen 420 illustrated in FIG. 4, the focus frame 420a has selected, as one of the menu items, a specific panel, for example, a function panel 421.

An arrow (mark) pointing an upper direction and an arrow (mark) pointing a lower direction are put on an upper side of the focus frame 420a and on a lower side of the focus frame 420a, respectively. A mark “<<” (double arrow in the left direction) and a mark “>>” (double arrow in the right direction) are put on a right side of the focus frame 420a and on a left side of the focus frame 420a, respectively. As has been described, these marks indicate directions in each of which a menu item is selectable. The double arrow indicates that a menu item is selectable at a speed higher than that in the direction indicated by the single arrow.

In a case where the function and recommend zone is focused, the focus frame 420a is fixed in a center part of the function and recommend zone 120. For example, in a case where the right button of the remote is pressed, a plurality of menu items located on a right side of the focus frame 420a are moved in a direction of the focus frame 420a thus fixed and then the menu item 422 adjacent to the right side of the focus frame 420a is moved within the focus frame 420a. That is, the plurality of menu items are entirely moved, by one (1), in a left direction.

Note that the mark “<<” (double arrow in the left direction) and the mark “>>” (double arrow in the right direction) are put on the right side of the focus frame 420a and on the left side of the focus frame 420a, respectively, so that the high speed selection is possible in the right-left direction. Accordingly, in a case where the right button of the remote is pressed and held down, the menu items are entirely moved at a high speed in the left direction. This makes it possible to make a high speed selection in a case where a menu item, located away from a currently focused menu item, is to be selected.

(In a Case where Internet Service Zone is Focused)

In a case where the down button of the remote is pressed while the menu screen 420 is being displayed, the screen is switched to a menu screen 430 displayed in a case where the Internet service zone is focused. It follows that, in this case, the focus frame 430a is located above a menu item located in a center part of the Internet service zone 130.

An arrow (mark) pointing an upper direction and an arrow (mark) pointing a lower direction are put on an upper side of the focus frame 420a and on a lower side of the focus frame 430a, respectively. The mark “<<” (double arrow in the left direction) and the mark “>>” (double arrow in the right direction) are put on a right side of the focus frame 430a and on a left side of the focus frame 430a, respectively. As has been described, these marks indicate directions in each of which a menu item is selectable. The double arrow indicates that a menu item is selectable at a speed higher than that in the direction indicated by the single arrow.

For example, in a case where the right button of the remote is pressed while the menu screen 430 is being displayed, i.e., while the focus frame 430a is being located in the center part of the Internet service zone 130, the focus frame is moved in a right direction so as to serve as a focus frame 432a, as shown in a menu screen 432. Similarly, in a case where the left button of the remote is pressed while the menu screen 430 is being displayed, the focus frame is moved in a left direction so as to serve as a focus frame 431a, as shown in a menu screen 431.

Note that, alternatively, it is possible to enlarge and display a menu item itself selected by the focus frame 430a. This allows the menu item thus selected to be clearly visible or text or the like written on the menu item to be easily readable.

In a case where a technique shown in FIG. 4 is considered as a method of displaying a menu, the method of displaying a menu shown in FIG. 4 can be described as a method of displaying a menu in which method a target menu item is selectable from a plurality of menu items which are displayed on a display screen, including the step of: providing, on the display screen, a focus frame indicating that a specific menu item has been selected from the plurality of menu items, a mark, indicative of a direction in which a menu item is selectable, being put around the focus frame, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

In a case where a technique shown in FIG. 4 is considered as a menu display device, the menu display device shown in FIG. 4 can be described as a menu display device in which a target menu item is selectable from a plurality of menu items which are displayed on a display screen, including: a control section which generates, on the display screen, a focus frame indicating that a specific menu item has been selected from the plurality of menu items, the control section putting, around the focus frame, a mark indicative of a direction in which a menu item is selectable, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

FIG. 6 illustrates a variation of the menu screen 410 in which a function and recommend zone is focused. A focus frame 500 has selected a function panel 121a, which is one of menu items in the function and recommend zone. Other function panels 121b and 121c are aligned on a left side of the function panels 121a. For example, recommended content panels 122a and 122b are aligned on a right side of the function panels 121a.

In this variation, the function panels 121b and 121c are each formed in trapezoid in which a right side (lower base of the trapezoid) is longest and a length between opposing oblique sides becomes gradually shorter as it comes closer to a left side (upper base of the trapezoid). On the other hand, the recommended content panels 122a and 122b are each formed in trapezoid in which a left side (lower base of the trapezoid) is longest and a length between opposing oblique sides becomes gradually shorter as it comes closer to a right side (upper base of the trapezoid). That is, menu items are arranged to be gradually smaller as they are farther away from the fixed focus frame 500.

With the arrangement, in a case where the right button or the left button of the remote is pressed for selecting a menu item, the menu item itself is moved in the left direction or the right direction, respectively. This allows a user to have a feeling as if the user were selecting one of menu items arranged in a ring shape by rotating the ring. In particular, in a case where the user makes the high speed selection, the user has a stronger feeling as if the user were selecting a menu item by rotating the ring. This allows the user to feel a pleasure in selecting a menu item itself.

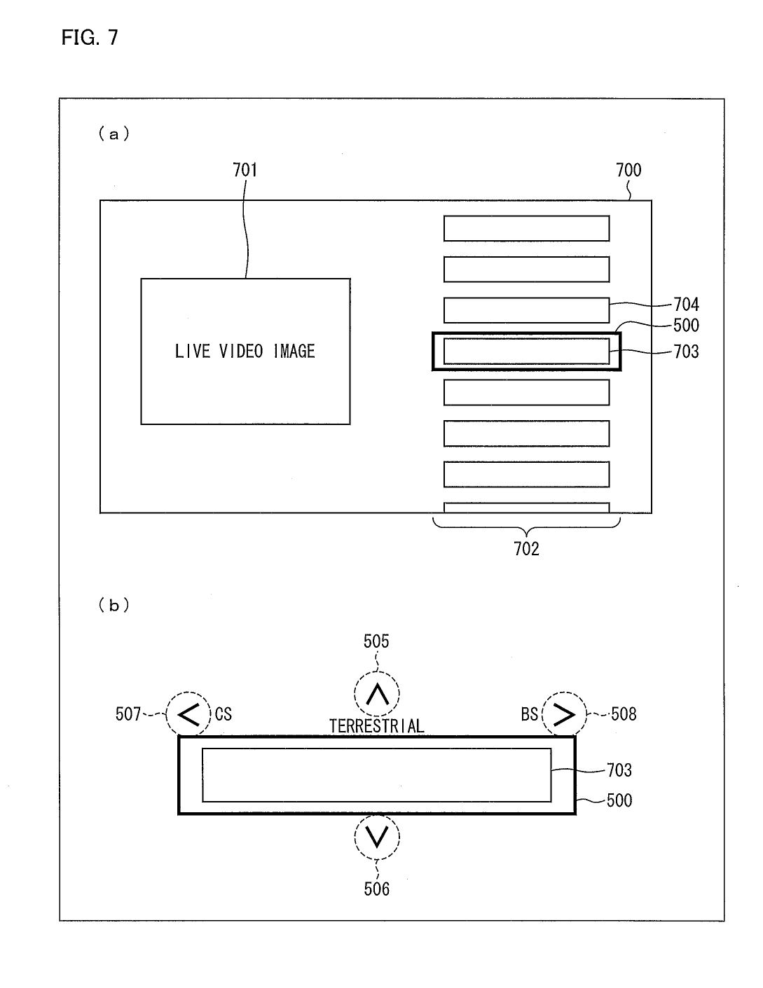

(a) and (b) of FIG. 7 illustrate examples of a menu screen displayed in a case where the screen is switched to the “counterprogram selection screen” or the “smart search screen” in FIG. 2. The following description will discuss on the premise that a menu screen 700 in (a) of FIG. 7 is a menu screen of the counterprogram selection screen. Note, however, that an operation conducted in a case where the menu screen 700 is a menu screen of the smart search screen is almost similar to that conducted in a case where the menu screen 700 is the menu screen of the counterprogram selection screen. Accordingly, the operation conducted in a case where the menu screen 700 is the menu screen of the smart search screen is not particularly discussed.

According to the menu screen 700 illustrated in (a) of FIG. 7, a small screen 701, on which a live picture that is being viewed is displayed, is secured on a left side of the display screen. Pieces of counterprogram information, which are menu items, are displayed in horizontal writing, are displayed in line in a longitudinal direction in a right side region 702 of the display screen. At the time when the screen is switched to the menu screen 700, the focus frame 500 focuses, out of a plurality of menu items, a menu item 703 located near a center part. Menu items to be first displayed can be always aligned in the menu screen 700 in the same order in accordance with a default value. Alternatively, it is possible that a channel, which is most recently selected and viewed, is to be focused through the use of a viewing history. The menu items can be arranged, in accordance with the viewing history, in descending order of the number of times being viewed. Alternatively, program titles, which can be currently selected, are preferentially arranged in accordance with the viewing history while judging by content of each program.

According to (b) of FIG. 7, the menu item 703 which is focused by the focus frame 500 is enlarged and displayed. Arrows 505, 506, 507, and 508 for indicating menu items selectable by the focus frame are illustrated around the focus frame 500 (see (b) of FIG. 7). According to the menu screen 700 illustrated in (a) of FIG. 7, the focus frame 500 is fixed near the center part illustrated in (a) of FIG. 7, and the menu items are moved in response to operation of the remote.

For example, in a case where the up button of the remote is pressed, a menu item 704, located above the menu item 703 which is currently focused, is selected in accordance with the arrow 505. This causes the menu items themselves to be entirely moved in a lower direction. As to the counterprogram selection screen, in a case where the OK button of the remote is pressed while a specific menu item is being focused (selected), a live picture is displayed in full screen. This causes a user to view a new counterprogram thus selected.

According to (b) of FIG. 7, an arrow indicating a left direction is displayed, together with text “CS,” in a left end part of an upper side of the focus frame 500. On the other hand, an arrow indicating a right direction is displayed, together with text “BS,” in a right end part of the upper side of the focus frame 500. In a case where the left button of the remote is pressed, the screen is switched to a state in which counterprogram information on CS broadcasting is displayed, and a program of the CS broadcasting is displayed in the right side region 702. Similarly, in a case where the right button of the remote is pressed, the screen is switched to a state in which counterprogram information on BS broadcasting is displayed, and a program of the BS broadcasting is displayed in the right side region 702.

According to (b) of FIG. 7, text “terrestrial” is displayed in a center part. This indicates that counterprogram information on terrestrial digital broadcasting is displayed in the right side region of the display screen. It follows that, after the CS broadcasting is selected, the text “CS” is displayed in the center part of the display screen. This causes the text “terrestrial” to be displayed either in the right region or in the left region of the display screen. Note that, according to the example shown in (b) of FIG. 7, no double arrow, indicating that the high speed selection is possible, is illustrated but it is needless to say that the high speed selection can be optionally made in a case where there are an extreme number of broadcasting channels or other cases.

As illustrated in the function and recommend zone 120 in FIG. 4, it is also possible to enlarge and display (zoom) a size of a menu item focused by the focus frame, while making an adjustment so that the size of the menu item is reduced in accordance with a distance of the menu item from the focus frame. This allows a menu item, which is being currently selected, to be more noticeable, and ultimately allows an improvement in user's visibility.

This makes it possible that, in a case where menu items themselves are moved, it appears to a user as if the menu items themselves were moving in a ring shape, as with the example of the menu screen 410 illustrated in FIG. 6. This makes it possible to provide a convenient television 1 which allows a user to find a kind of pleasure, for example, in conducting an operation itself of searching for a target menu item.

Enlarging and displaying of a menu item focused by the focus frame can be carried out on and after completion of a movement of the focus frame (or a movement of the menu item itself). A menu item can be gradually enlarged so as to reach a target size, from a time point at which the movement of the focus frame (or the movement of the menu item itself) starts to a time point at which the movement of the focus frame is completed.

The television 1 can be alternatively arranged such that the menu item is not enlarged and displayed while the focus frame is being moved at a high speed in an identical zone (i.e., while the high speed selection is being made). In this arrangement, the menu item can be enlarged and displayed at a time point when a menu item to be focused is determined after the focus frame completes being moved at the high speed.

This allows the television 1 to prevent a reduction in user's visibility which is caused by enlarging and displaying menu items one after another while the focus frame is being moved at a high speed. With the above arrangement, the television 1 does not need to carry out processing relevant to enlargement and displaying of the menu item while the focus frame is being moved at a high speed. This allows a reduction in throughput required for moving the focus frame at a high speed.

### (Arrangement of Menu Display Device)

The menu display is realized by picture image processing section 203, the LCD controller 204, the LCD 205, and the control section 220 of the television 1 illustrated in FIG. 3. In a case where the menu display is controlled by software, the menu display is mainly realized by the control section 220.

That is, a menu display device in which a target menu item is selectable from a plurality of menu items which are displayed on a display screen is realized by a control section 220 having the following functions. That is, the control section 220 has a function of generating, on the display screen, a focus frame indicating that a specific menu item has been selected from the plurality of menu items, the control section 220 further having a function of putting, around the focus frame, a mark indicative of a direction in which a menu item is selectable, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

Note that the method of displaying a menu, the menu display device, and the like of the present invention are applicable to not only a television receiver but also a device in which a number of menu items need to be selected, and are applicable, for example, to a smartphone or the like.

(Program and Storage Medium)

As has been described, according to the hardware configuration of the television 1 illustrated in FIG. 3, various types of controls are carried out by the control section 220. It follows that the control section 220 displays the menu screen, focuses (selects) a specific menu item by use of the focus frame, and the like described above. Such a control can be implemented by hardware such as a logic circuit provided in an integrated circuit (IC chip) or can be alternatively implemented by software with the use of a CPU (Central Processing Unit).

In the latter case, the control section 220 includes a CPU that executes an instruction of a program that realizes respective functions; a ROM (Read Only Memory) that stores the program, a RAM (Random Access Memory) in which the program is loaded, and a storage device (storage medium) such as a memory that stores the program and various kinds of data. The object of the present invention can be also attained by supplying, to the control section 220, a storage medium, in which a program code (execute form program, intermediate code program, source program) for a control program, i.e., software that realizes the above-mentioned functions, of the control section 220, is stored readably by a computer, and by reading and executing the program code stored in the storage medium by the computer (or CPU or MPU).

The storage medium may use any of tapes, such as a magnetic tape and a cassette tape; any of disks including magnetic disks, such as a Floppy (registered trademark) disk and a hard disk, and optical disks, such as a CD-ROM, an MO, an MD, a DVD, and a CD-R; any of cards, such as an IC card (including a memory card) and an optical card; any of semiconductor memories, such as a mask ROM, an EPROM, an EEPROM (registered trademark), and a flash ROM; or any of logic circuits, such as a PLD (Programmable Logic Device) and a FPGA (Field Programmable Gate Array).

The program code may be received by various types of receivers such as the television 1 via the broadcasting or a communication network. This communication network is not particularly limited as long as the communication network can transmit the program code. For example, the Internet, an intranet, an extranet, a LAN, an ISDN, a VAN, a CATV communication network, a virtual private network, a telephone line network, a mobile communication network, or a satellite communication network may be used. A transmission medium forming the communication network is only required to transmit the program code, and hence is not limited to a specific configuration or a specific type. For example, the transmission medium may be a wired configuration, such as IEEE1394, a USB, a power-line carrier, a cable TV line, a telephone line, or ADSL (Asymmetric Digital Subscriber Line) line; or a wireless configuration, such as an infrared ray (e.g., IrDA or remote control), Bluetooth (registered trademark), IEEE802.11 radio, HDR (High Data Rate), NFC (Near Field Communication), DLNA (Digital Living Network Alliance), a mobile phone network, a satellite line, or a terrestrial digital network.

### CONCLUSION

As has been described above, a menu display device of Aspect 1 of the present invention is a menu display device in which a target menu item is selectable from a plurality of menu items which are displayed on a display screen, including: a control section which generates, on the display screen, a focus frame indicating that a specific menu item has been selected from the plurality of menu items, the control section putting, around the focus frame, a mark indicative of a direction in which a menu item is selectable, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

With the arrangement, it is possible to obtain a menu display device in which a target menu item is easily selectable from a number of menu items by simply moving a menu frame and which clearly indicates a direction in which a high speed selection is possible since there are a number of menu items. For example, in a case where such a menu display device is employed in a television receiver, it is possible to clearly indicate that the high speed selection is possible (i) in a direction in which an item is to be selected from a number of contents, (ii) in a direction in which an item is to be selected from a number of recommended themes, or (iii) in a direction in which an item is to be selected from a number of channels as with a channel selection. This allows a user to easily recognize that the high speed selection is possible and to make a selection, in a short time period, in a direction in which a number of items are aligned. This makes it possible to provide a convenient television receiver or the like.

In addition to the configuration of the menu display device of Aspect 1, a menu display device of Aspect 2 of the present invention is configured such that the high speed selection is made by moving the focus frame at a high speed on the display screen, whereas the low speed selection is made by moving the focus frame at a speed lower than the high speed.

With the arrangement, in a case where a long time period is required for selecting a menu item since there are a number of menu items to be selected, it is possible to make a selection, in a short time period, in a direction in which a number of items are aligned by making the high speed selection. This makes it possible to provide a convenient television receiver or the like.

In addition to the configuration of the menu display device of Aspect 1 or 2, a menu display device of Aspect 3 of the present invention is configured such that the focus frame repeats blinking on a certain cycle.

With the arrangement, the focus frame can be easily visible. There is a case where the menu items contain various colors so that a focus frame of any color or a focus frame of any luminance may not be noticeable. In a case where a luminance of the focus frame periodically changes, it is possible to extremely easily recognize whether or not a target menu item is selected, so as to improve operation ability.

In addition to the configuration of the menu display device of Aspect 3, a menu display device of Aspect 4 of the present invention is configured such that a blinking state of the focus frame is reset each time the focus frame is moved.

With the arrangement, the focus frame can be easily visible. While the focus frame is periodically blinking, a timing when the focus frame is moved may be accidentally coincident with a timing when a luminance becomes lowest during the blinking of the focus frame. In such a case, a location of the focus frame momentarily becomes unclear, so that a user is confused. In a case where the blinking state of the focus frame is reset to a bright state when the focus is moved, the location of the focus frame which has been moved becomes clear so as to improve operation ability.

In addition to the configuration of the menu display device of Aspect 1, a menu display device of Aspect 5 of the present invention is configured such that the focus frame indicating a selected menu item is fixed in a center part of the plurality of menu items; and a menu item is selected by moving the menu item within the focus frame.

With the arrangement, a menu frame itself is always located in a center of a group of items to be selected, so as to achieve the highest visibility. Since the menu frame is located in a fixed part, a selected menu item can be easily confirmed.

In addition to the configuration of the menu display device of Aspect 5, a menu display device of Aspect 6 of the present invention is configured such that the high speed selection is made by moving the plurality of menu items at a high speed, whereas the low speed selection is made by moving the plurality of menu items at a speed lower than the high speed.

With the arrangement, in a case where a long time period is required for selecting a menu item since there are a number of menu items to be selected, it is possible to make a selection, in a short time period, in a direction in which a number of items are aligned by making the high speed selection. This makes it possible to provide a convenient television receiver or the like.

In addition to the configuration of the menu display device of any of Aspects 1 through 6, a menu display device of Aspect 7 of the present invention is configured such that a selected menu item itself is enlarged and displayed.

With the arrangement, a selected menu item is easily visible. In a case where text is written in a menu item, such text can be easily visible. In a case where telop display is included, a telop can be moved in accordance with an enlargement of the screen. This makes it possible to provide a convenient menu display device.

In addition to the configuration of the menu display device of any of Aspects 5 through 7, a menu display device of Aspect 8 of the present invention is configured such that a menu item gradually becomes smaller as the menu item is farther away from a fixed focus frame.

With the arrangement, in a case where a user moves the menu items themselves in order to select a target menu item, it appears to the user as if the menu items themselves were rotating in a ring shape. That is, it appears to the user as if a number of menu items were arranged in a form of a cylindrical rotor, so that the user visually recognizes that the menu items are naturally being moved. This allows the user to find a kind of pleasure, for example, in conducting an operation itself of searching for a target menu item. This makes it possible to provide a convenient menu display device.

In addition to the configuration of the menu display device of any of Aspects 1 through 8, a menu display device of Aspect 9 of the present invention is configured such that the control section puts, as the mark indicating the direction in which the menu item is selectable, marks which are different in accordance with the number of selectable menu items.

With the arrangement, in a case where there are a number of selectable menu items, the menu display device can show a user the approximate number of selectable menu items by putting different marks (e.g., by increasing the number of arrows) in accordance with the number of menu items. This allows the user to recognize, by simply taking a glance at the marks put around the focus frame, the approximate number of selectable menu items included in an identical zone.

In addition to the configuration of the menu display device of any of Aspects 3 through 9, a menu display device of Aspect 10 of the present invention is configured such that a difference in luminance between a bright state and a dark state of the focus frame is adjusted while the focus frame is blinking.

With the arrangement, it is possible to avoid causing a problem that a user has an impression that the user is in a state of emergency, so as to rush the user to conduct an operation.

In addition to the configuration of the menu display device of Aspect 7, a menu display device of Aspect 11 of the present invention is configured such that a selected menu item is not enlarged and displayed while the high speed selection is being made.

With the arrangement, the menu display device can prevent a reduction in user's visibility which is caused by enlarging and displaying menu items one after another while the focus frame is being moved at a high speed. With the above arrangement, the menu display device does not need to carry out processing relevant to enlargement and displaying of the menu item while the focus frame is being moved at a high speed. This allows a reduction in throughput required for moving the focus frame at a high speed.

A television receiver of Aspect 12 of the present invention is configured to include: a menu display device recited in any one of Aspects 1 through 11.

With the arrangement, it is possible to clearly indicate that the high speed selection is possible (i) in a direction in which an item is to be selected from a number of contents, (ii) in a direction in which an item is to be selected from a number of recommended themes, or (iii) in a direction in which an item is to be selected from a number of channels as with a channel selection. This allows a user to easily recognize that the high speed selection is possible and to make a selection, in a short time period, in a direction in which a number of items are aligned. This makes it possible to provide a convenient television receiver or the like.

A method of displaying a menu of Aspect 13 of the present invention is a method of displaying a menu in which method a target menu item is selectable from a plurality of menu items which are displayed on a display screen, including the step of: providing, on the display screen, a focus frame indicating that a specific menu item has been selected from the plurality of menu items, a mark, indicative of a direction in which a menu item is selectable, being put around the focus frame, the mark, indicative of the direction in which the menu item is selectable, including (i) a first mark indicative of a direction in which a high speed selection is possible and (ii) a second mark indicative of a direction in which a low speed selection is possible, the first and second marks differing from each other.

With the arrangement, it is possible to obtain a method of displaying a menu in which method (i) a target menu item is easily selectable from a number of menu items by simply moving a menu frame and (ii) the high speed selection can be made in accordance with the number of menu items.

A program of Aspect 14 of the present invention is a program which causes a computer to operate as a menu display device recited in any one Aspects 1 through 11 and to function as each means of the menu display device.

With the arrangement, it is possible to extremely easily provide a convenient menu display device.

A computer readable storage medium of Aspect 15 of the present invention is a computer readable storage medium storing the program of Aspect 14, which program causes a computer to function as each means of the menu display device.

With the arrangement, it is possible to easily and securely distribute a program which causes the computer to function as each means of the menu display device.

Note that the embodiments discussed in the foregoing description serve solely to illustrate the technical details of the present invention, which should not be narrowly interpreted within the limits of such embodiments, but rather may be applied in many variations within the spirit of the present invention, provided such variations do not exceed the scope of the claims set forth below.

### INDUSTRIAL APPLICABILITY

The present invention provides a method of displaying a menu and the like which facilitates an operation of a multifunctionalized television receiver and the like whose operation is complicated, so that the present invention has high industrial applicability.

### REFERENCE SIGNS LIST

1: Television receiver
100: Menu screen
110: Information zone
111: User name display region
112a: Message list button
112b: Login button
112c: Setting button
113: Time display region
114: Weather display region
115: Live picture display region
116a through 116c: Banner
116d: Banner detail display region
117: Information display region
120: function and recommend zone
121: Function panel
122: Recommended content panel
130: Internet service zone
131: Icon corresponding to Internet service
201: Tuner
202: Video recorder
203: Picture processing section
204: LCD controller
205: LCD
206: Audio decoder
207: Audio processing section
208: Amplifier
209: Speaker
210: HDMI receiver
211: LAN interface
220: Control section
400: Television display screen
410, 411, 412: Menu screen in which information zone is focused
410a, 411a, 412a: Focus frame
420: Menu screen in which function and recommend zone is focused
420a: Focus frame
421: Function panel (menu item)
422: Menu item
430, 431, 432: Menu screen in which Internet service zone is focused
430a, 431a, 432a: Focus frame
500: Focus frame
501, 502: Arrow indicating that low speed selection is possible
503, 504: Arrow indicating that high speed selection is possible
700: Menu screen for counterprogram selection

1-15. (canceled)

16. A menu display device in which a target menu item is selectable from a plurality of menu items which are displayed on a display screen, comprising:
a control section which generates, on the display screen, a focus frame indicating that a specific menu item has been selected from the plurality of menu items,
the control section putting, around the focus frame, a mark indicative of a direction in which a menu item is selectable.

17. The menu display device as set forth in claim 16, wherein the mark, indicative of the direction in which the menu item is selectable, including (i) a first mark indicative of a direction in which a high speed selection is possible and (ii) a second mark indicative of a direction in which a low speed selection is possible, the first and second marks differing from each other.

18. The menu display device as set forth in claim 17, wherein the high speed selection is made by moving the focus frame at a high speed on the display screen, whereas the low speed selection is made by moving the focus frame at a speed lower than the high speed.

19. The menu display device as set forth in claim 16, wherein the focus frame repeats blinking on a certain cycle.

20. The menu display device as set forth in claim 19, wherein a blinking state of the focus frame is reset each time the focus frame is moved.

21. The menu display device as set forth in claim 16, wherein:
the focus frame indicating a selected menu item is fixed in a center part of the plurality of menu items; and
a menu item is selected by moving the menu item within the focus frame.

22. The menu display device as set forth in claim 17, wherein:
the focus frame indicating a selected menu item is fixed in a center part of the plurality of menu items;
a menu item is selected by moving the menu item within the focus frame; and
the high speed selection is made by moving the plurality of menu items at a high speed, whereas the low speed selection is made by moving the plurality of menu items at a speed lower than the high speed.

23. The menu display device as set forth in claim 16, wherein a selected menu item itself is enlarged and displayed.

24. The menu display device as set forth in claim 21, wherein a menu item gradually becomes smaller as the menu item is farther away from a fixed focus frame.

25. The menu display device as set forth in claim 16, wherein the control section puts, as the mark indicating the direction in which the menu item is selectable, marks which are different in accordance with the number of selectable menu items.

26. The menu display device as set forth in claim 19, wherein a difference in luminance between a bright state and a dark state of the focus frame is adjusted while the focus frame is blinking.

27. The menu display device as set forth in claim 17, wherein:
a selected menu item itself is enlarged and displayed; and
a selected menu item is not enlarged and displayed while the high speed selection is being made.

28. The menu display device as set forth in claim 16, wherein:
the control section puts, as the mark indicating the direction in which the menu item is selectable, a mark which includes n single arrows; and
the n is a value corresponding to the number of menu items selectable by moving the focus frame in the direction.

29. The menu display device as set forth in claim 16, wherein:
in a case where an up button or a down button of a remote control of the menu display device is pressed, the control section causes the focus frame to move in a direction corresponding to the up button or the down button thus pressed; and
in a case where a right button or a left button of the remote control is pressed, the control section causes the menu item to move in a direction corresponding to the right button or the left button thus pressed.

30. The menu display device as set forth in claim 16, wherein the control section causes the menu item to move at a high speed, whereas the control section causes the focus frame to move at a speed lower than the high speed.

31. A television receiver comprising:
the menu display device recited in claim 16.

32. A method of displaying a menu by a menu display device in which method a target menu item is selectable from a plurality of menu items which are displayed on a display screen, comprising the steps of:
causing a control section of the menu display device to display the plurality of menu items on the display screen;
causing the control section to generate, on the display screen, a focus frame indicating that a specific menu item has been selected from the plurality of menu items; and
causing the control section to put, around the focus frame, a mark indicative of a direction in which a menu item is selectable.

33. A non-transitory computer readable storage medium storing a program which causes a computer to operate as a menu display device recited in claim 16 and to function as the control section of the menu display device.
